(19) United States
(12) Patent Application Publication
(10) Pub. No.: US 2024/0429422 A1
(43) Pub. Date: Dec. 26, 2024

(54) ELECTROCHEMICAL CELL SYSTEM WITH STACK COMPRESSION

(71) Applicant: Twelve Benefit Corporation, Berkeley, CA (US)

(72) Inventors: Adel B Jilani, North Vancouver (CA); Simon Gregory Stone, Arlington, MA (US)

(21) Appl. No.: 18/745,133

(22) Filed: Jun. 17, 2024

Related U.S. Application Data
(60) Provisional application No. 63/509,526, filed on Jun. 21, 2023.

(51) Int. Cl. H01M 8/248; C25B 9/70; H01M 8/2404

(52) U.S. Cl. CPC H01M 8/248; C25B 9/70; H01M 8/2404

(57) ABSTRACT

Various electrochemical cell systems are provided. Some systems have a cathode end plate, an anode end plate, one or more electrochemical cells positioned between the cathode and anode end plates, tension members connecting the cathode end plate with the anode end plate, and tensioning devices, each configured to apply a tension force to one or more of the tension members such that the corresponding tension member or tension members apply a local compression force to a corresponding local portion of the cathode and anode end plates. The cathode and anode end plates distribute an aggregate compression force across the one or more electrochemical cells responsive, at least in part, to each corresponding local portion of the cathode and anode end plates receiving the local compression force from the corresponding tension member or tension members; each tensioning device is positioned between spaced apart from the cathode and anode end plates.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Electrochemical cells may generate electrical energy from the chemical reactions occurring in those cells, or use electrical energy supplied to them to facilitate chemical reactions in them. Examples of electrochemical cells may include electrolyzer cells and fuel cells. Electrolyzer cells offer a potential route for converting or reducing COₓ gas, e.g., CO or CO₂, into one or mor e desired carbon-based byproducts, such as industrial chemicals or fuels, thereby allowing for waste COₓ gas that would normally be released into the atmosphere to instead be converted into industrially useful products.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY OF THE INVENTION

An electrochemical cell system may be provided that includes a cathode end plate, an anode end plate, and one or more electrochemical cells positioned between the cathode end plate and anode end plate. The electrochemical cell system may further include a plurality of tension members connecting the cathode end plate with the anode end plate. The electrochemical cell system may further include a plurality of tensioning devices, each configured to apply a tension force to one or more of the tension members such that the corresponding tension member or tension members apply a local compression force to a corresponding local portion of the cathode end plate and the anode end plate. The cathode end plate and the anode end plate may distribute an aggregate compression force across the one or more electrochemical cells disposed between the cathode end plate and the anode end plate responsive, at least in part, to each corresponding local portion of the cathode end plate and the anode end plate receiving the local compression force from the corresponding tension member or tension members. Each tensioning device may be positioned between the cathode end plate and the anode end plate and is spaced apart from each of the cathode end plate and the anode end plate.

In some implementations, the electrochemical cell system may further include one or more regions that are adjacent to the cathode end plate and the anode end plate and free of the tensioning devices, thereby further providing clearance for accessing one or more components connected to a corresponding one of the cathode end plate and the anode end plate.

In some implementations, one or both of the cathode end plate and the anode end plate may include a first face, a second face opposite to the first face and directed towards the one or more electrochemical cells, and one or more peripheral sides extending between the first face and the second face. The tension members may be connected to the peripheral sides of one or both of the cathode end plate and the anode end plate. The tension members may be positioned adjacent to the one or more electrochemical cells.

In some implementations, the cathode end plate and the anode end plate may each include the corresponding first face, the corresponding second face, and the corresponding one or more peripheral sides. The electrochemical cell system may further include a plurality of cathode plate pins extending from the one or more peripheral sides of the cathode end plate. The electrochemical cell system may further include a plurality of anode plate pins extending from the one or more peripheral sides of the anode end plate. Each tension member may include a first rod having a first end pivotably connected to one of the cathode plate pins and a second end including a first threaded portion. Each tension member may further include a second rod having a first end pivotably connected to one of the anode plate pins and a second end including a second threaded portion. The first threaded portion and the second threaded portion of each tension member may be threaded in opposite directions. Each tension member may further include one or more of the tensioning devices. The tensioning device of each tension member may include a corresponding first threaded portion rotationally coupled with the first threaded portion of the first rod of that tension member. The tensioning device of each tension member may further include a corresponding second threaded portion rotationally coupled with the second threaded portion of the second rod of that tension member. The corresponding first threaded portion and the corresponding second threaded portion of the tensioning device of each tension member may be threaded in opposite directions. The tensioning device of each tension member may be configured to decrease the tension force in that tension member responsive, at least in part, to that tensioning device rotating in a first rotational direction relative to the first and second rods. The tensioning device of each tension member may be configured to increase the tension force in that tension member responsive, at least in part, to that tensioning device rotating in a second rotational direction opposite to the first rotational direction.

In some implementations, the tensioning device of each tension member may have an outer surface that includes a plurality of flat sides configured to be engaged by a rotational drive device to facilitate rotation of the tensioning device by rotating the rotational drive device in the first rotational direction or the second rotational direction.

In some implementations, each tension member may include a corresponding spring having a spring constant associated with the tension force.

In some implementations, the tensioning device of each tension member may include a tubular body with a helical slot along a length of the tubular body.

In some implementations, the tension members may include at least a first tension member and a second tension member. A first tensioning device of the tensioning devices may be configured to apply the tension force to the first tension member and the second tension member simultaneously.

In some implementations, each of the first tension member and the second tension member may include one or more connectors configured to connect with the first tensioning device. Each one of the first tension member and the second tension member may further include a first load spreader connected to two or more pins that extend from one of the peripheral sides of the cathode end plate. Each one of the first tension member and the second tension member may further include one or more first links connecting the first load spreader with the one or more connectors. Each one of the first tension member and the second tension member may further include a second load spreader connected to two or more pins that extend from one of the peripheral sides of the anode end plate. Each one of the first tension member and the second tension member may further include one or more second links connecting the second load spreader with the one or more connectors. The first tensioning device may be configured to apply the tension force to the first links and the second links of the first tension member and the first links and the second links of the second tension member via the one or more connectors.

In some implementations, the first tension member may include a first threaded portion, and the second tension member includes a second threaded portion. The first threaded portion of the first tension member and the second threaded portion of the second tension member may be threaded in opposite directions. The first tensioning device may include a corresponding first threaded portion rotationally coupled with the first threaded portion of the first tension member. The first tensioning device may further include a corresponding second threaded portion rotationally coupled with the second threaded portion of the second tension member. The corresponding first threaded portion and the corresponding second threaded portion of the first tensioning device may be threaded in opposite directions. The first tensioning device may be configured to decrease the tension force in the first tension member and the second tension member responsive, at least in part, to the first tensioning device rotating in a first rotational direction relative to the first and second links. The first tensioning device may be configured to increase the tension force in the first tension member and the second tension member responsive, at least in part, to the first tensioning device rotating in a second rotational direction opposite to the first rotational direction.

In some implementations, the first tensioning device may have an outer surface that includes a plurality of flat sides configured to be engaged by a rotational drive device to facilitate rotation of that first tensioning device by rotating the rotational drive device in the first rotational direction or the second rotational direction.

In some implementations, each tension member may include a corresponding spring having a spring constant associated with the tension force.

In some implementations, the first tensioning device of each tension member may include a tubular body with a helical slot along a length of the tubular body.

In some implementations, each of the one or more electrochemical cells may be an electrolyzer cell or a fuel cell.

In some implementations, the electrochemical cell system may further include one or more actuators configured to rotate the corresponding tensioning devices. The electrochemical cell system may further include a controller configured to control the actuators to rotate the corresponding tensioning devices and adjust the tension forces applied to the tension members.

In some implementations, the electrochemical cell system may further include one or more sensors configured to generate an input signal associated with data indicative of one or more parameters of the one or more electrochemical cells. The controller may be configured to compare the one or more parameters to a threshold setpoint. The controller may be further configured to generate an actuation signal responsive, at least in part, to the controller determining that the one or more parameters are outside a predetermined range of the threshold setpoint. The actuator may be configured to adjust the tension force responsive, at least in part, to the actuator receiving the actuation signal from the controller.

In some implementations, the electrochemical cell system may further include one or more pressure sensors configured to generate a pressure input signal associated with data indicative of one or more pressures within the one or more electrochemical cells. The controller may be configured to compare the one or more pressures to a maximum pressure threshold. The controller may be further configured to generate a first actuation signal responsive, at least in part, to the controller determining that the one or more pressures are above the maximum pressure threshold. The actuator may rotate the tensioning device in a first rotational direction relative to the first and second tension members to decrease the tension force responsive, at least in part, to the actuator receiving the first actuation signal from the controller.

In some implementations, the controller may be configured to compare the one or more pressures to a minimum pressure threshold. The controller may be further configured to generate a second actuation signal responsive, at least in part, to the controller determining that the one or more pressures are below the minimum pressure threshold. The actuator may rotate the tensioning device in a second rotational direction opposite to the first rotational direction to increase the tension force responsive, at least in part, to the actuator receiving the second actuation signal from the controller.

A method may be provided for configuring an electrochemical cell system. The electrochemical cell system may include a cathode end plate, an anode end plate, one or more electrochemical cells positioned between the cathode end plate and the anode end plate, a plurality of tension members connecting the cathode end plate with the anode end plate, and a plurality of tensioning devices. The method may include applying, using the tensioning devices, a tension force to one or more of the tension members such that the corresponding tension member applies a local compression force to a corresponding local portion of the cathode end plate and the anode end plate. The method may further include distributing, using the cathode end plate and the anode end plate, an aggregate compression force across the one or more electrochemical cells disposed between the cathode end plate and the anode end plate responsive, at least in part, to each corresponding local portion of the cathode end plate and the anode end plate receiving the local compression force from the corresponding tension member. The method may further include disposing each tensioning device between the cathode end plate and the anode end plate. The method may further include spacing each tensioning device apart from each of the cathode end plate and the anode end plate.

In some implementations, the method may further include providing one or more regions that are adjacent to the cathode end plate and the anode end plate and free of the tensioning devices, thereby further providing clearance for accessing one or more components connected to a corresponding one of the cathode end plate and the anode end plate.

In some implementations, one or both of the cathode end plate and the anode end plate may include a first face, a second face opposite to the first face and directed towards the one or more electrochemical cells, and one or more peripheral sides extending between the first face and the second face. The method may further include connecting the tension members to the peripheral sides of one or both of the cathode end plate and the anode end plate. The method may further include disposing the tension members adjacent to the one or more electrochemical cells, thereby decreasing a bending moment of the cathode end plate and the anode end plate.

In some implementations, the method may further include pivotably connecting a first end of a first rod to one of a plurality of cathode plate pins extending from the one or more peripheral sides of the cathode end plate. The first rod may include a second end including a first threaded portion. The method may further include pivotably connecting a first end of a second rod to one of a plurality of anode plate pins extending from the one or more peripheral sides of the anode end plate. The second rod may include a second end including a second threaded portion. The tensioning device of the corresponding tension member may include a corresponding first threaded portion rotationally coupled with the first threaded portion of the first rod of that tension member. The tensioning device of the corresponding tension member may further include a corresponding second threaded portion rotationally coupled with the second threaded portion of the second rod of that tension member. The method may further include rotating the tensioning device of the corresponding tension member in a first rotational direction relative to the first and second rods. The method may further include decreasing, using the tensioning device of each tension member, the tension force in that tension member responsive, at least in part, to that tensioning device rotating in the first rotational direction. The method may further include rotating the tensioning device of the corresponding tension member in a second rotational direction. The method may further include increasing, using the tensioning device of each tension member, the tension force in the that tension member responsive, at least in part, to that tensioning device rotating in the second rotational direction opposite to the first rotational direction.

In some implementations, the method may further include applying, using a first tensioning device of the tensioning devices, the tension force to a first tension member and a second tension member simultaneously.

In some implementations, the method may further include connecting one or more connectors of each one of the first tension member and the second tension member to the first tensioning device. The method may further include connecting a first load spreader of each one of the first tension member and the second tension member to two or more pins that extend from one of the peripheral sides of the cathode end plate. The method may further include connecting, using one or more first links of each one of the first tension member and the second tension member, the first load spreader with the one or more connectors. The method may further include connecting a second load spreader of each one of the first tension member and the second tension member to two or more pins that extend from one of the peripheral sides of the anode end plate. The method may further include connecting, using one or more second links of each one of the first tension member and the second tension member, the second load spreader with the one or more connectors. The method may further include applying, using the first tensioning device, the tension force to the first links and the second links of the first tension member and the first links and the second links of the second tension member simultaneously.

In some implementations, the method may further include rotating, in a first rotational direction relative to the first and second links, the first tensioning device. The first tensioning device may include a corresponding first threaded portion rotationally coupled with a first threaded portion of the first tension member and a corresponding second threaded portion rotationally coupled with a second threaded portion of the second tension member. The method may further include decreasing, using that first tensioning device, the tension force in the tension member responsive, at least in part, to that first tensioning device rotating in the first rotational direction.

In some implementations, the method may further include rotating, in a second rotational direction opposite to the first rotational device, that first tensioning device. The method may further include increasing, using that first tensioning device, the tension force in the tension member responsive, at least in part, to that first tensioning device rotating in the second rotational direction.

### BRIEF DESCRIPTION OF THE FIGURES

FIG. 1 depicts a perspective view of one example of an electrochemical cell system having multiple tension members connected to a cathode end plate and an anode end plate, with multiple tensioning devices spaced apart from the cathode end plate and the anode end plate.

FIG. 2 depicts an enlarged upper perspective view of a portion of the cathode end plate of FIG. 1, with one of the tension members removed to illustrate a pin for use in pivotably coupling the tension member to a peripheral side of the cathode end plate.

FIG. 3 depicts an enlarged lower perspective view of a portion of the anode end plate of FIG. 1, with one of the tension members removed to illustrate a pin for use in pivotably coupling the tension member to a peripheral side of the anode end plate.

FIGS. 4 and 5 depict enlarged perspective views of a portion of a first tension member of FIG. 1, illustrating a first rod of the first tension member having a bearing for pivotably coupling the first rod to the cathode end plate and further having a first threaded portion.

FIGS. 6 and 7 depict enlarged perspective views of another portion of the first tension member of FIG. 1, illustrating a second rod of the tension member having a bearing for pivotably connecting the second rod to the anode end plate and further having a second threaded portion.

FIG. 8 depicts an enlarged perspective view of a first tensioning device of the first tension member of FIG. 1, illustrating the first tensioning device having a corresponding first threaded end portion and a corresponding second threaded end portion configured to apply a tension force to the first rod and the second rod.

FIG. 9 depicts another example of a tensioning device of FIG. 8, illustrating the tensioning device including a spring with a helical slot.

FIG. 10 depicts a cross-sectional view of the tensioning device of FIG. 9 as taken along line 10-10.

FIG. 11 depicts a perspective view of another example of the electrochemical cell system of FIG. 1, illustrating each tensioning device applying a tension force to two tension members, with each tension member having a first load spreader, a first link, a second load spreader, and a second link.

FIG. 12 depicts an enlarged upper perspective view of the cathode end plate of FIG. 11, illustrating two first load spreaders distributing local compressive forces to corresponding portions of the cathode end plate via four cathode plate pins.

FIG. 13 depicts an enlarged lower perspective view of the anode end plate of FIG. 11, illustrating two second load spreaders distributing local compressive forces to corresponding portions of the anode end plate via four anode plate pins.

FIG. 14 depicts an enlarged perspective view of a first tensioning device of the tensioning devices of FIG. 11, illustrating the first tensioning device configured to apply the tension force to the first tension member and the second tension member simultaneously.

FIG. 15 depicts a perspective view of yet another example of the electrochemical cell system of FIG. 1, illustrating the electrochemical cell system having a controller and an actuator.

FIG. 16 depicts a flow chart of an example method of configuring the electrochemical cell system of FIG. 1.

FIG. 17 depicts a flow chart of another example method of configuring the electrochemical cell system of FIG. 15.

### DETAILED DESCRIPTION

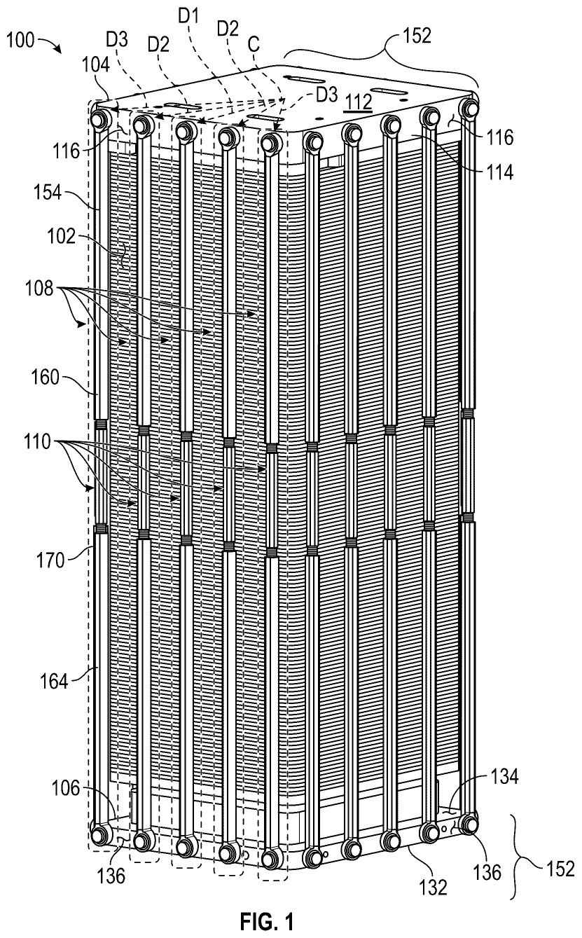

Referring to FIG. 1, an electrochemical cell system 100 includes one or more electrochemical cells 102 (e.g., fuels cells, electrolyzer cells, etc.) positioned between a cathode end plate 104 and an anode end plate 106. Each electrochemical cell 102 includes at least a membrane electrode assembly (MEA) and a gas diffusion layer (GDL) that experience expansion and contraction responsive, at least in part, to changes in temperature and moisture during operation and/or assembly of the electrochemical cell system 100. As described in detail below, the electrochemical cell system 100 includes a plurality of tension members 108 and a plurality of tensioning devices 110 that distribute local compression forces to the cathode end plate 104 and the anode end plate 106 so as to decrease bending of the cathode end plate 104 and the anode end plate 106 corresponding with the expansion and contraction experienced during operation and/or assembly of the electrochemical cell system 100. The tensioning devices 110 are connected with the peripheral sides 116 of the cathode end plate 104 and the anode end plate 106, thereby leaving the top and bottom surfaces of the cathode end plate 104 and the anode end plate 106, respectively, free of such structural connections and allowing for other components (e.g., port blocks) to be easily attached to those surfaces.

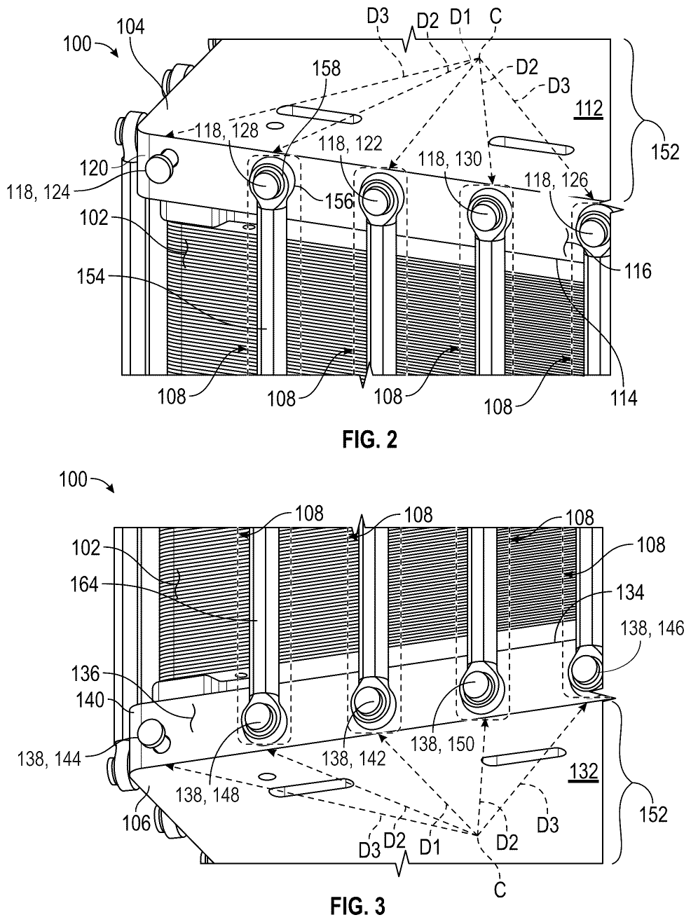

As best shown in FIG. 2, the cathode end plate 104 includes a first face 112 for attaching one or more components, e.g., port blocks (not shown) that may be used to provide fluids to inlets or outlets of the electrochemical cell stack (e.g., via oblong ports visible in FIG. 2), to the cathode end plate 104. The cathode end plate 104 further includes a second face 114, which is opposite to the first face 112 and directed towards one or more electrochemical cells 102. The cathode end plate 104 further includes one or more peripheral sides 116 extending between the first face 112 and the second face 114. A plurality of cathode plate pins 118 extends from the peripheral sides 116 of the cathode end plate 104. The pins 118 (e.g., bolts, screws, etc.) may be separate components connected to the peripheral sides 116 of the cathode end plate 104 or, in another example, the pins 118 may be integral portions of the cathode end plate 104. In this example, the cathode end plate 104 has a quadrilateral shape with four peripheral sides 116 and four rounded corners 120. On each peripheral side 116, the cathode end plate 104 may have five cathode plate pins 118 including a first pin 122 extending from a centermost position on that peripheral side 116, a second pin 124 extending from a first end of that peripheral side 116 adjacent to one of the rounded corners 120, a third pin 126 extending from a second end of that peripheral side 116 adjacent to another rounded corner 120, a fourth pin 128 extending from that peripheral side 116 at a position between the first pin 122 and the second pin 124, and a fifth pin 130 extending from that peripheral side 116 at a position between the first pin 122 and the third pin 126. A distance D1 (e.g., a first moment arm) from the center C of the cathode end plate 104 to the first pin 122 at the centermost position is shorter than a common distance D2 (e.g., a second moment arm) from the center C of the cathode end plate 104 to either one of the fourth pin 128 or the fifth pin 130. Furthermore, the common distance D2 is shorter than a common distance D3 (e.g., third moment arm) from the center of the cathode end plate 104 to either one of the second pin 124 or the third pin 126. As described below, in view of the different moment arms corresponding with the different distances D1, D2, D3, the tension members 108 and the tensioning devices 110 may distribute tension forces among the pins 118 to provide a uniform bending moment about the cathode end plate 104 to thereby decrease bending of the cathode end plate 104. In other examples, the cathode end plate 104 may have other suitable shapes with any number of sides (e.g., any polygonal shape with a corresponding number of peripheral sides, a circular shape, etc.) and pins 118 positioned at any suitable location on the cathode end plate 104. The pins 118 may be spaced apart from one another by at least 40 mm. Also, in other examples, the cathode end plate 104 may have more or fewer than five pins 118 (e.g., four pins) on each peripheral side 116, and the spacing between any of the pins 118 may be any suitable distance above or below 40 mm.

Referring to FIG. 3, the anode end plate 106 is similar to the cathode end plate 104 of FIG. 2 and includes similar components identified by the same numbers increased by 20 (e.g., the cathode plate pins 118 compared to anode plate pins 138). While the cathode plate pins 118 of FIG. 2 extend from the peripheral sides 116 of the cathode end plate 104, a plurality of anode plate pins 138 extend from the peripheral sides 136 of the anode end plate 106. In other examples, the anode end plate 106 may be different from the cathode end plate 104. More specifically, in another example, only one of the cathode end plate 104 and the anode end plate 106 may have the pins 118, 138, respectively, extending from the corresponding peripheral sides 116, 136. The other of the cathode end plate 104 and the anode end plate 106 may have a plurality of through-holes (not shown) extending from the first face 132 to the second face 134. Furthermore, the tension members 108 may extend through the corresponding through-holes (not shown), such that a plurality of threaded nuts (not shown) may engage the tension member 108 and the first face 132. In such implementations, the end plate (e.g., one of the cathode end plate 104 and the anode end plate 106) having the through-holes (not shown) may be sized larger than the end plate (e.g., the other of the cathode end plate 104 and the anode end plate 106) having the pins, such that each through-hole, when viewed along its center axis, generally aligns with one of the pins.

Referring to FIGS. 1-3, the tension members 108 are connected to the peripheral sides 116, 136 of one or both of the cathode end plate 104 and the anode end plate 106 by, for example, the corresponding pins 118, 138. In this example, the tension members 108 are connected to the peripheral sides 116, 136 of both the cathode end plate 104 and the anode end plate 106 by the pins 118, 138, respectively. Also, in this example, the electrochemical cell system 100 includes twenty tension members 108. Five of the twenty tension members 108 may connect a corresponding one of the first pin 122, the second pin 124, the third pin 126, the fourth pin 128, and the fifth pin 130 on each one of the four peripheral sides 116 of the cathode end plate 104 with a corresponding one of the first pin 142, the second pin 144, the third pin 146, the fourth pin 148, and the fifth pin 150 on each one of the four peripheral sides 136 of the anode end plate 106. In another example, the electrochemical cell system 100 may include sixteen tension members 108. Four of the sixteen tension members 108 may connect each peripheral side 116 of the cathode end plate 104 with each peripheral side 136 of the anode end plate 106. In other examples, the electrochemical cell system 100 may have any suitable number of tension members 108, with more or fewer than five tension members 108 connecting any portion of the cathode end plate 104 with any portion of the anode end plate 106. Also, in this example, each tension member 108 is positioned adjacent to the electrochemical cells 102 so as to further decrease a bending moment on the cathode end plate 104 and the anode end plate 106.

One or more of the tension members 108 are connected with the peripheral sides 116 of the cathode end plate 104 and the anode end plate 106, thereby leaving the top and bottom surfaces of the cathode end plate 104 and the anode end plate 106, respectively, free of such structural connections and allowing for other components (e.g., port blocks) to be easily attached to those surfaces. In this example, the first face 112 of the cathode end plate 104 and the first face 132 of the anode end plate 106 are free from the tension members 108, thereby providing access to components (e.g., port blocks) in the regions 152 adjacent to each first face 112, 132.

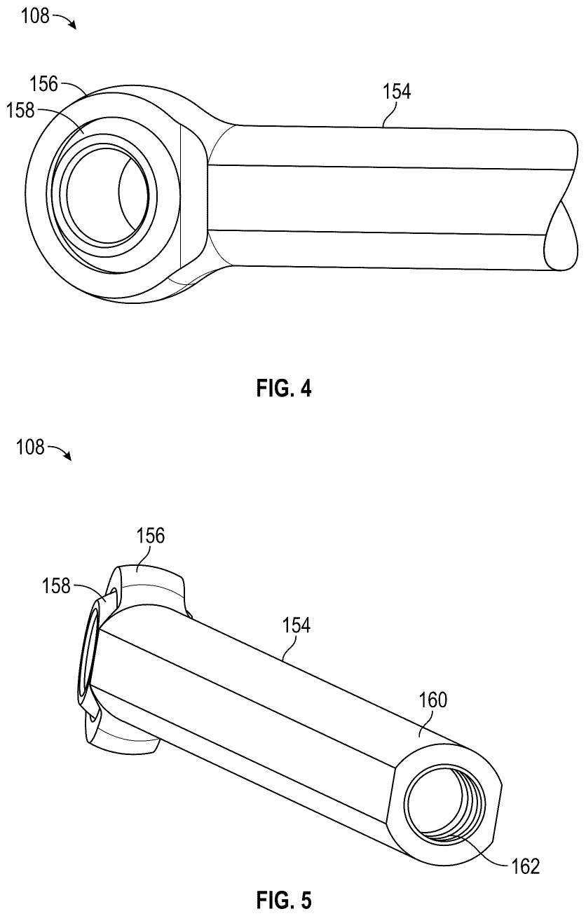

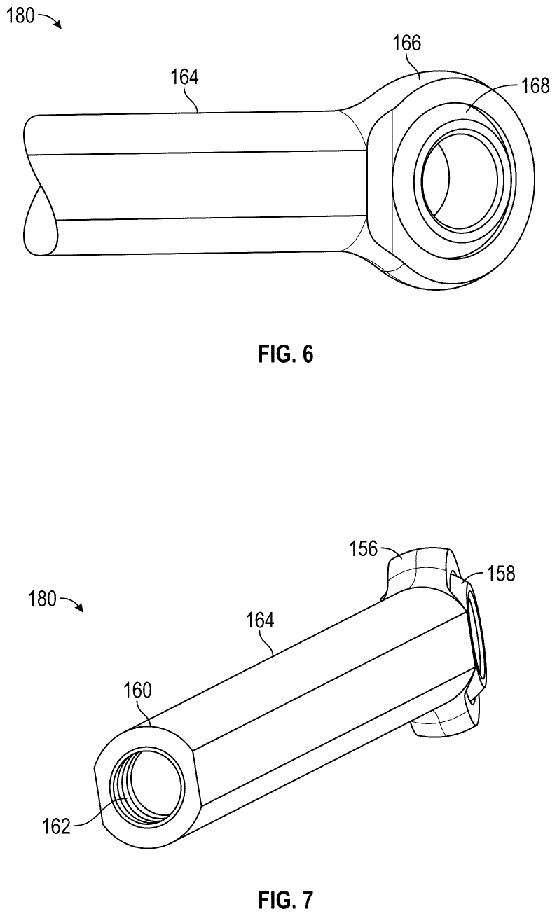

Referring to FIGS. 4 and 5, each tension member 108 includes a first rod 154 having a first end 156 pivotably connected to a corresponding cathode plate pin 118. In some implementations, as shown, the first end 156 may include a ball joint bearing 158 configured to be supported on the corresponding cathode plate pin 118 (FIG. 2). The first rod 154 further includes a second end 160 having a first threaded portion 162 (FIG. 5).

Referring to FIGS. 6 and 7, each tension member 108 further includes a second rod 164 that is similar to the first rod 154 of FIGS. 4 and 5 and has the same components identified by the same numbers increased by 10. In an analogous manner, while the first rod 154 includes the first end 156 with the ball joint bearing 158 configured to be supported on the corresponding cathode plate pin 118 (FIG. 2) and transmit the tension force to the cathode end plate 104, the second rod 164 includes a first end 166 with a ball joint bearing 168 configured to be supported on the corresponding anode plate pin 138 (FIG. 3) and transmit the tension force to the anode end plate 106. Additionally, in a somewhat similar manner that the first rod 154 includes the second end 160 (FIG. 5) with the first threaded portion 162, the second rod 164 includes a second end 170 with a second threaded portion 172 (FIG. 7). The first threaded portion 162 and the second threaded portion 172 are threaded in opposite directions.

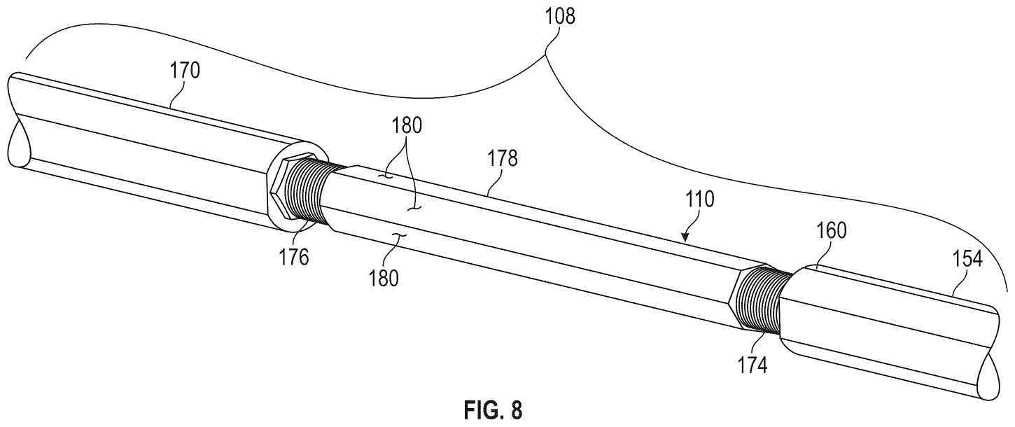

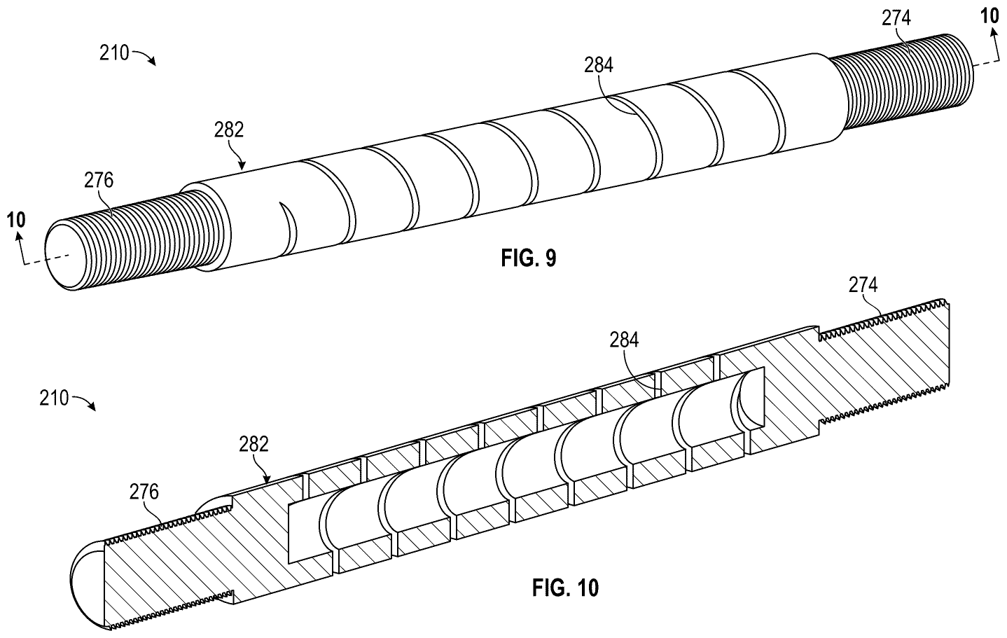

Referring to FIGS. 1 and 8, each tensioning device 110 is configured to apply a tension force to one or more of the tension members 108 such that the corresponding tension member 108 or tension members 108 apply a local compression force to a corresponding local portion of the cathode end plate 104 and the anode end plate 106. More specifically, each tension member 108 may apply a local compression force with a magnitude that depends on the moment arm associated with that tension member, such that each tension member 108 may apply a common bending moment on the cathode end plate 104 and the anode end plate 106 thereby decreasing bending of the plates 104, 106. In other examples, the tensioning device 110 may apply any tension force to the tension members 108 to provide a uniform or non-uniform bending moment to one or both of the bipolar end plates 104, 106.

Each tensioning device 110 is positioned between the cathode end plate 104 and the anode end plate 106 and is spaced apart from each of the cathode end plate 104 and the anode end plate 106, thereby further providing clearance for accessing one or more components (e.g., port blocks) connected to a corresponding one of the cathode end plate 104 and the anode end plate 106. In this example, each tension member 108 includes one of the tensioning devices 110 (e.g., a turnbuckle, etc.). The tensioning device 110 of each tension member 108 includes a corresponding first threaded portion 174 (FIG. 8) rotationally coupled with the first threaded portion 162 of the first rod 154 (FIG. 5) of that tension member 108. The tensioning device 110 of each tension member 108 further includes a corresponding second threaded portion 176 (FIG. 8) rotationally coupled with the second threaded portion 172 of the second rod 164 (FIG. 7) of that tension member. The corresponding first threaded portion 174 and the corresponding second threaded portion 176 of the tensioning device 110 of each tension member 108 are threaded in opposite directions. The tensioning device 110 of each tension member 108 is configured to decrease the tension force in that tension member 108 responsive, at least in part, to that tensioning device 108 rotating in a first rotational direction relative to the first and second rods. The tensioning device 110 of each tension member 108 is configured to increase the tension force in that tension member 108 responsive, at least in part, to that tensioning device 110 rotating in a second rotational direction opposite to the first rotational direction and relative to the first and second rods. The tensioning device 110 of each tension member 108 has an outer surface 178 with a plurality of flat sides 180 configured to be engaged by a rotational drive device (not shown), e.g., a box wrench, to facilitate rotation of the tensioning device 110 by rotating rotational drive device in the first rotational direction or the second rotational direction. Each tensioning device 110 may further include a first jam nut that may be carried by the first threaded portion 174 and configured to be rotated so as to engage an end of the first rod 154 thereby preventing further rotation of the tensioning device 110 relative to the first rod 154 (e.g., after the tension device 110 has been rotated to a predetermined position to transmit a predetermined tension force to the tension member 108). Each tensioning device 110 may further include a second jam nut that may be carried by the second threaded portion 178 and configured to be rotated so as to engage an end of the second rod 164 thereby preventing further rotation of the tensioning device 110 relative to the second rod 164 (e.g., after the tension device 110 has been rotated to a predetermined position to transmit a predetermined tension force to the tension member 108).

The cathode end plate 104 and the anode end plate 106 distribute an aggregate compression force across the one or more electrochemical cells 102 disposed between the cathode end plate 104 and the anode end plate 106 responsive, at least in part, to each corresponding local portion of the cathode end plate 104 and the anode end plate 106 receiving the local compression force from the corresponding tension member 108.

Each tension member includes one or more components having a predetermined coefficient of stiffness. In another implementation, the tensioning device 210 may further include one or more springs (FIGS. 9 and 10) having a spring constant that is associated with the tension force (e.g., a coefficient of stiffness that is significantly less than coefficient of stiffness corresponding with components of each tension member). Another example may include a tubular body 282 with a helical slot 284 along a length of the tubular body 282. In this example, the spring constant of the tubular body 282 may be within 1% of the spring constant of the first rod 154 and the second rod 164. The tubular body 282 may be connected to the corresponding first threaded portion 274 and the corresponding second threaded portion 276 by threaded, welding, or other suitable fastening methods. In other examples, the tubular body, the corresponding first threaded portion, and the corresponding second threaded portion may be integral portions of a single-piece body (e.g., via additive manufacturing processes, lathe milling, casting, etc.). While the depicted implementation of the corresponding first threaded portion and the corresponding second threaded portion are external male threadings on the tubular body, other implementations of the corresponding first threaded portion and/or the corresponding second threaded portion may be internal female threadings within the tubular body.

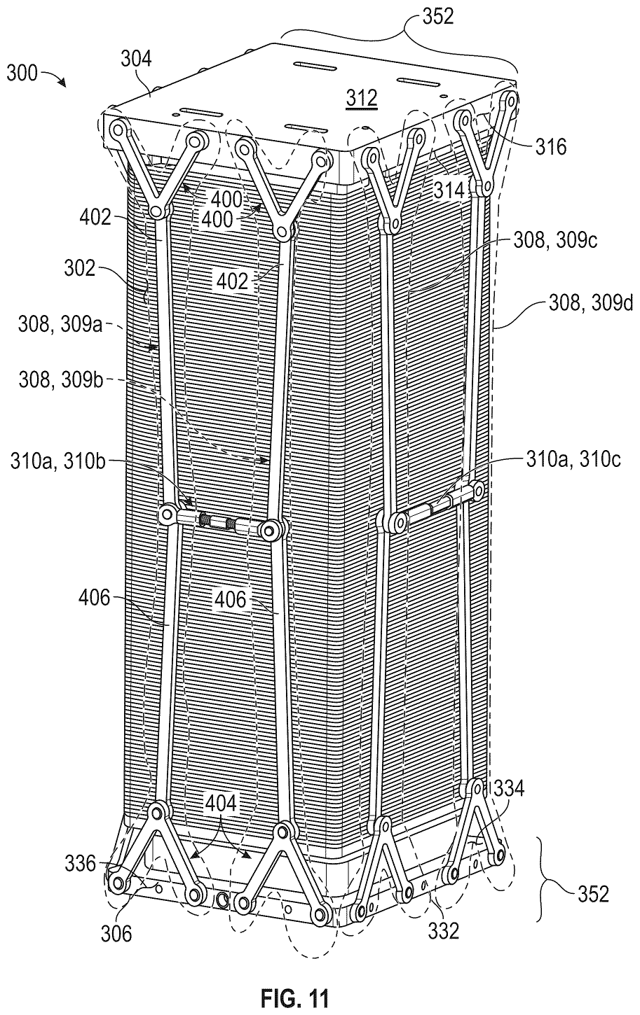

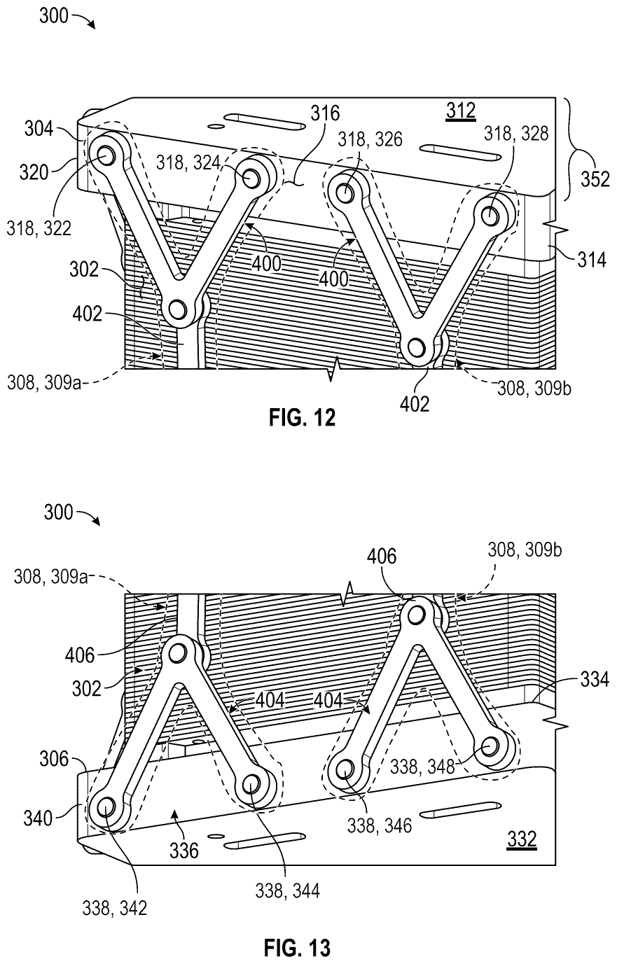

Referring to FIGS. 11-14, another example of an electrochemical cell system 300 is depicted that is similar to the electrochemical cell system 100 of FIG. 1 and has the same or similar components identified by the same numbers increased by 200. However, while the cathode end plate 104 of FIG. 1 includes five cathode plate pins 118 on each peripheral side 116 of the cathode end plate 104, the cathode end plate 304 of FIG. 12 includes four cathode plate pins 318 on each peripheral side 316 of the cathode end plate 304. More specifically, the cathode plate pins 318 may include a first pin 322, a second pin 324, a third pin 326, and a fourth pin 328 on each peripheral side 316 of the cathode end plate 104. The anode end plate 306 of FIG. 13 is similar to the cathode end plate 304 and has similar components identified by the same numbers increased by 20.

While the tension members 108 of FIG. 1 include five tension members 108 pivotably coupled to five corresponding cathode plate pins 118 on each peripheral side 116 (e.g., a first peripheral side, a second peripheral side, etc.) of the cathode end plate 104 (e.g., a first peripheral side), the tension members 308 of FIG. 11 include a first tension member 309a connected to two of the four cathode plate pins 318 (e.g., the first pin 322 and the second pin 324) on the first peripheral side 316 of the cathode end plate 304 and two of the four anode plate pins 338 (e.g., the first pin 342 and the second pin 344) on the first peripheral side 336 of the anode end plate 306. The tension members 308 further include a second tension member 309b connected to the other two cathode plate pins 318 (e.g., the first pin 326 and the second pin 328) on the first peripheral side 316 of the cathode end plate 304 and the other two anode plate pins 338 (e.g., the first pin 346 and the second pin 348) on the first peripheral side 336 of the anode end plate 306. In a similar manner, the tension members 308 may further include additional tension members 308 for other peripheral sides 316, 336 of the cathode end plate 304 and the anode end plate 306 (e.g., a third tension member 309c and a fourth tension member 309d on second peripheral side 316, 336 of the cathode end plate 304 and the anode end plate 306, etc.).

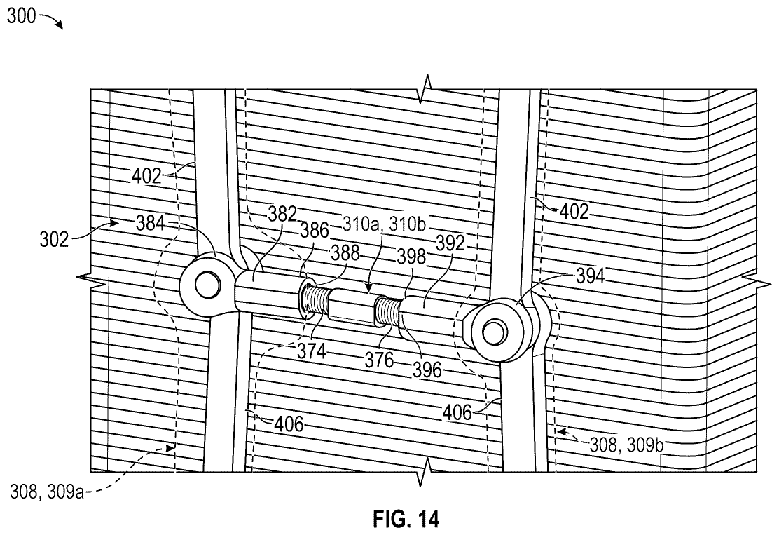

While each tensioning device 110 of FIG. 1 is configured to apply a tension force to one tension member 108, each tensioning device 310a of FIG. 11 is configured to apply the tension force to at least the first tension member 309a and the second tension member 309b simultaneously, as described in detail below. In this example, each of the first tension member 309a and the second tension member 309b includes a connector configured to connect with the first tensioning device 310b of the tensioning devices 310a. More specifically, as best shown in FIG. 14, the first tension member 309a may have a first connector 382 with a first end 384 and a second end 386. The second end 386 includes a first threaded portion 388. The second tension member 309b may have a second connector 392 with a first end 394 and a second end 396. The second end 396 includes a second threaded portion 398. The first threaded portion 388 and the second threaded portion 398 may be threaded in opposite directions. In some implementations, the first threaded portion 388 and the second threaded portion 398 may be internal female threadings within a tubular body, other implementations of the first threaded portion or the second threaded portion may be external male threadings on the tubular body. Other peripheral sides 316, 336 of the cathode end plate 304 and the anode end plate 306 (e.g., the remaining three sides of the quadrilateral bipolar end plates 304, 306) may include similar arrangements of tensioning devices (e.g., a second tensioning device 310c, a third tensioning device, and a fourth tensioning device) that are connected to opposing peripheral sides 116, 136 of the cathode end plate 104 and the anode end plate 106, respectively.

Each of the first tension member 309a and the second tension member 309b further includes a first load spreader 400 of FIG. 12 connected to two or more pins 318 extending from one of the peripheral sides 316 of the cathode end plate 304. Each of the first tension member 309a and the second tension member 309b further includes one or more first links 402 connecting the first load spreader 400 with the corresponding connector 382, 392. Each of the first tension member 309a and the second tension member 309b further includes a second load spreader 404 of FIG. 13 connected to two or more pins 338 that extend from one of the peripheral sides 336 of the anode end plate 306. Each of the first tension member 309a and the second tension member 309b further includes one or more second links 406 that connect the second load spreader 404 with the corresponding connector 382, 392. In other examples, one or more of the first links 402 or the second links 406 may be connected directly to the first tensioning device 310b. In still other examples, one or more of the first links 402 or second links 406 may be directly or indirectly connected with the first tensioning device 310b.

Referring to FIG. 14, the first tensioning device 310b is configured to apply the tension force to the first links 402 and the second links 406 of the first tension member 309a, as well as the first links 402 and the second links 406 of the second tension member 309b simultaneously. The first tensioning device 310b includes a corresponding first threaded portion 374 rotationally coupled with the first threaded portion 388 of the first connector 382 and a corresponding second threaded portion 376 rotationally coupled with the second threaded portion 398 of the second connector 392. The corresponding first threaded portion 374 and the corresponding second threaded portion 376 of the first tensioning device 310b are threaded in opposite directions. The first tensioning device 310b is configured to decrease the tension force in the first tension member 309a and the second tension member 309b responsive, at least in part, to the first tensioning device 310b rotating in a first rotational direction relative to the first and second links 402, 406. The first tensioning device 310b is configured to increase the tension force in the first tension member 309a and the second tension member 309b responsive, at least in part, to the first tensioning device 310b rotating in a second rotational direction opposite to the first rotational direction. The first tensioning device 310b has an outer surface 378 having a plurality of flat sides 380 configured to be engaged by a rotational drive device (not shown) to facilitate rotation of that first tensioning device 310b by rotating the rotational drive device in the first rotational direction or the second rotational direction. In some implementations including two or more additional tensioning devices 310a (e.g., a second tensioning device 310c, a third tensioning device, a fourth tensioning device, etc.), those tensioning devices may be configured to apply the tension force to corresponding tension members (e.g., the third tension member 509c, the fourth tension member 509d, etc.) in a similar manner as the first tensioning device 310b.

In some implementations, each tension member 308 (e.g., the first tension member 309a, the second tension member 309b, the third tension member 309c, the fourth tension member 309d, etc.) may include one or more components having a predetermined coefficient of stiffness, and each tensioning device 310a may further include one or more springs (FIGS. 9 and 10) having a spring constant (e.g., a coefficient of stiffness that is significantly less than the coefficient of stiffness of the components of the tension members 309a, 309b). The first tensioning device 310b may be a linear actuator that may incorporate a roller screw, a ball screw, a short-throw actuator, and/or the like.

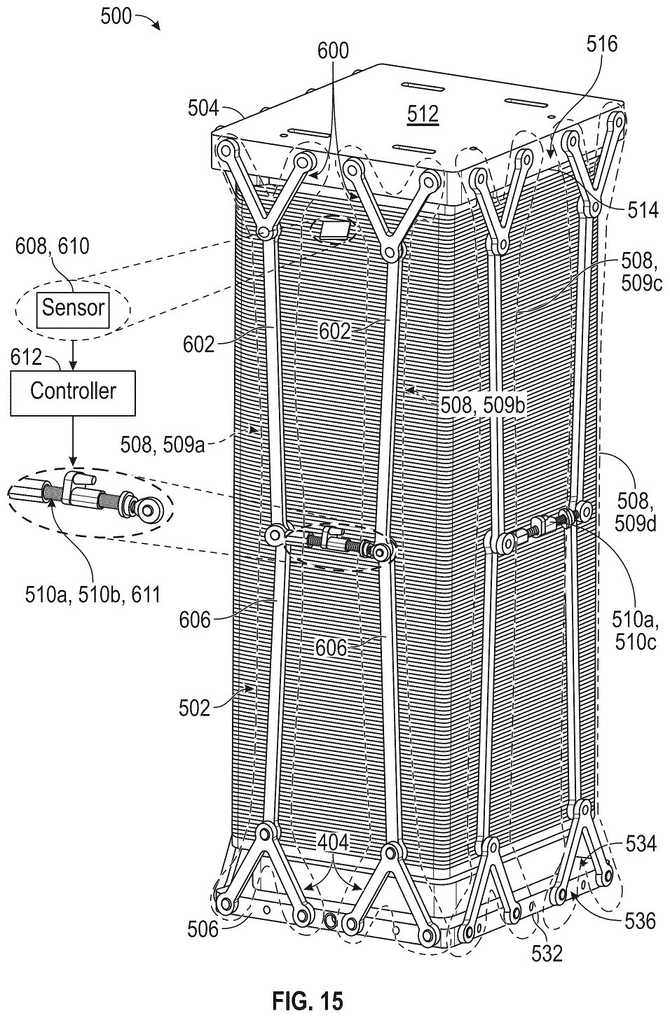

Referring to FIG. 15, another example of an electrochemical cell system 500 is similar to the electrochemical cell system 300 of FIG. 11 and includes the same components identified by the same numbers increased by 200. However, while each tensioning device 310a of FIG. 11 includes a plurality of flat sides configured to be engaged by a rotational drive device to facilitate rotation of the tensioning device 310 by rotating the rotational drive device in the first rotational direction or the second rotational direction, the tensioning device 510 of FIG. 15 is configured to be rotated by an actuator 611 (e.g., a roller screw, etc.) in the first rotational direction or the second rotational direction, as described in detail below.

The electrochemical cell system 500 includes one or more sensors 608 configured to generate an input signal associated with data indicative of one or more parameters of the one or more electrochemical cells 502. The sensors 608 may include one or more pressure sensors 610 configured to generate a pressure input signal associated with data indicative of one or more pressures within the one or more electrochemical cells 502. One or more electrochemical cells 502 may include other suitable sensors that detect parameters corresponding with the aggregate compression force that the cathode end plate 504 and the anode end plate 506 distribute across the one or more electrochemical cells 502. In other implementations, the sensors 608 may be connected to the tension members 508. Examples of those sensors 608 may include strain gauges configured to measure tension in each tension member 508 or tension in the pair of first and second tension members 509a, 509b when tension is balanced between the first and second tension members 509a, 509b. In still other examples, the sensors 608 may further include strain gauges or other sensors configured to measure tension in pairs of tension members 508 on one or more of the peripheral sides (e.g., the third tension member 509c, the fourth tension member 509d, etc.).

The electrochemical cell system 500 may further include a controller 612 configured to control the tensioning devices 510a (e.g., the first tensioning device 510b, the second tensioning device 510c, etc.) to adjust the tension forces applied to the tension members 508 (e.g., the first tension member 509a, the second tension member 509b, the third tension member 509c, the fourth tension member 509d, etc.). More specifically, the controller 612 may be configured to compare the one or more parameters to a threshold setpoint. The controller 612 may be configured to generate an actuation signal responsive, at least in part, to the controller 612 determining that the one or more parameters are outside a predetermined range of the threshold setpoint. The actuator 611 may be configured to adjust the tension force responsive, at least in part, to the actuator 611 receiving the actuation signal from the controller. In this example, the controller 612 may be configured to compare the one or more pressures to a maximum pressure threshold, and generate a first actuation signal responsive, at least in part, to the controller 612 determining that the one or more pressures are above the maximum pressure threshold. The actuator 611 may rotate in a first rotational direction relative to the first and second links 602, 606 to decrease the tension force responsive, at least in part, to the actuator 611 receiving the first actuation signal from the controller 612. In another example, the controller 612 may be configured to compare the one or more pressures to a minimum pressure threshold, and generate a second actuation signal responsive, at least in part, to the controller 612 determining that the one or more pressures are below the minimum pressure threshold. The actuator 611 may rotate in a second rotational direction opposite to the first rotational direction to increase the tension force responsive, at least in part, to the actuator 611 receiving the second actuation signal from the controller 612.

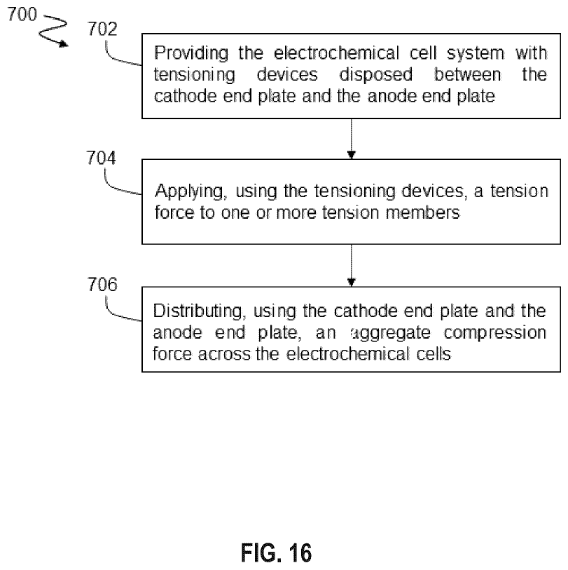

Referring to FIG. 16, an example of a method 700 for operating the electrochemical cell system 100 of FIG. 1 begins at block 702 with providing the electrochemical cell system 100 having the tension members 108 that connect to the peripheral sides 116 of one or both of the cathode end plate 104 and the anode end plate 106. In this example, the method 700 may include connecting the tension members 108 to the peripheral sides 116, 136 of both of the cathode end plate 104 and the anode end plate 106 via the pins 118, 138. More specifically, each tension member 108 may include the first rod 154 and the second rod 164. In such examples, the method 700 includes pivotably connecting the first end 156 of each first rod 154 to one of the cathode plate pins 118 extending from the corresponding peripheral side 116 of the cathode end plate 104. The method 700 further includes pivotably connecting the first end 166 of each second rod 164 to one of the anode plate pins 138 extending from the corresponding peripheral side 136 of the anode end plate 106. In other examples, the method 700 may include pivotably connecting the first end 156 of each first rod 154 directly to any suitable portion of the cathode end plate 104 (e.g., the first face 112, the second face 114, etc.) or pivotably connecting the first end 166 of each second rod 164 directly to any suitable portion of the anode end plate 104 (e.g., the first face 132, the second face 134, etc.). In still other examples, one end of the tension member 108 may be connected with the corresponding end plate in a non-pivotal manner, e.g., inserted through or threaded into a corresponding hole (not shown) in that end plate, or may be connected pivotally with that end plate. While this example of the method 700 includes connecting, using five tension members 108, each peripheral side 116 of the cathode end plate 104 with the corresponding peripheral side 136 of the anode end plate 106, other examples of the method 700 may include connecting, using more or fewer than five tension members 108 (e.g., four tension members), any suitable portion of the cathode end plate 104 with any corresponding suitable portion of the anode end plate 106. Furthermore, while the above examples of electrochemical cell systems 100 include connections between plates and tension members that are the first ends 156 of first rods 154 and the first ends 166 second rods 164, other examples of the electrochemical cell systems 100 may include any other connections (e.g., connections that have rotation about the pin axis, but not about other axes).

Block 702 may further include disposing each tensioning device 110 between the cathode end plate 104 and the anode end plate 106 and spacing apart each tensioning device 110 from each of the cathode end plate 104 and the anode end plate 106. The method 700 further includes providing one or more regions adjacent to the cathode end plate 104 and the anode end plate 106 (e.g., regions 152 adjacent to the first face 112, 132 of the cathode end plate 104 and the anode end plate 106) that are free of the tensioning devices 110, thereby further providing clearance for accessing one or more components connected to the cathode end plate 104 and the anode end plate 106. The method 700 further includes disposing the tension members 108 adjacent to the one or more electrochemical cells 102 so as to decrease a bending moment of the cathode end plate 104 and the anode end plate 106 (e.g., by minimizing a moment arm thereof). The method 700 then proceeds to block 704.

At block 704, the method 700 includes applying, using the tensioning devices 110, a tension force to one or more of the tension members 108 such that the corresponding tension member 108 applies a local compression force to a corresponding local portion of the cathode end plate 104 and the anode end plate 106. In this example, the method 700 may include rotating the tensioning device 110 of the corresponding tension member 108 in the first rotational direction. The method 700 further includes decreasing, using the tensioning device 110 of each tension member 108, the tension force in that tension member 108 responsive, at least in part, to that tensioning device 110 rotating in the first rotational direction. In other examples, the method 700 may further include rotating the tensioning device 110 of the corresponding tension member 108 in the second rotational direction. The method 700 further includes increasing, using the tensioning device 110 of each tension member 108, the tension force in that tension member 108 responsive, at least in part, to that tensioning device 110 rotating in the second rotational direction opposite to the first rotational direction. The method 700 then proceeds to block 706.

At block 706, the method 700 includes distributing, using the cathode end plate 104 and the anode end plate 106, an aggregate compression force across the electrochemical cells 102 disposed between the cathode end plate 104 and the anode end plate 106 responsive, at least in part, to each corresponding local portion of the cathode end plate 104 and the anode end plate 106 receiving the local compression force from the corresponding tension member 108.

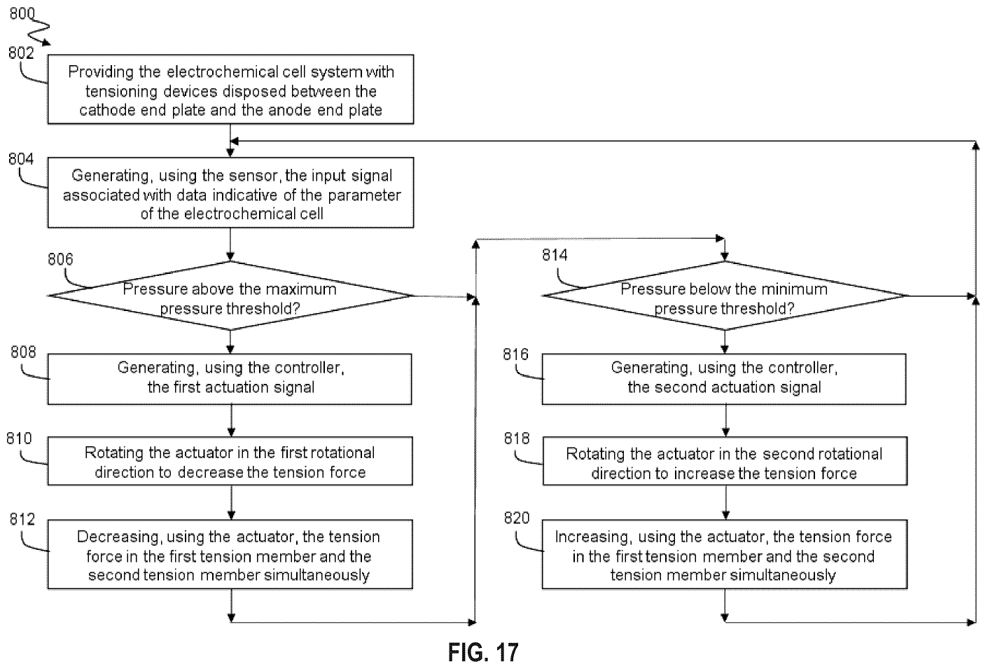

Referring to FIG. 17, an example of a method 800 of configuring the electrochemical cell system 500 of FIG. 15 begins at block 802 with providing the electrochemical cell system 100 with the tension members 508 (e.g., the first tension member 509a, the second tension member 509b, the third tension member 509c, the fourth tension member 509d, etc.) that connect to the peripheral sides 516, 536 of one or both of the cathode end plate 504 and the anode end plate 506. While this method 800 is similar to the method 700 of FIG. 16 that includes connecting the tension members 108 to the peripheral sides 116, 136 of both of the cathode end plate 104 and the anode end plate 106 via the pins 118, 138, this method 800 includes connecting the connectors 582, 592 of each one of the first tension member 509a and the second tension member 509b to the first tensioning device 510b. The method 800 may further include connecting the first load spreader 600 of each one of the first tension member 509a and the second tension member 509b to two or more cathode plate pins 518 that extend from one of the peripheral sides 516 of the cathode end plate 504. The method 800 may further include connecting, using one or more first links 602, the first load spreader 600 with the corresponding connector. The method 800 may further include connecting the second load spreader 604 of each one of the first tension member 509a and the second tension member 509b to two or more pins 536 that extend from one of the peripheral sides 538 of the anode end plate 506. The method 800 may further include connecting, using one or more second links 606, the second load spreader 604 with the corresponding connector. While this example of the method 800 includes connecting, using two tension members 509a, 509b, each peripheral side 516 of the cathode end plate 504 with the corresponding peripheral side 536 of the anode end plate 506, other examples of the method may include connecting, using more than two tension members, any suitable portion of the cathode end plate 104 with any corresponding suitable portion of the anode end plate 106. Similar to the method 700 of FIG. 16, this method 800 further includes disposing each tensioning device 510a between the cathode end plate 504 and the anode end plate 506 and spacing apart each tensioning device 510a from each of the cathode end plate 504 and the anode end plate 506. The method 800 then proceeds to block 804.

At block 804, the method 800 includes generating, using one or more sensors 608, an input signal associated with data indicative of one or more parameters of the one or more electrochemical cells 502. In this example, the method 800 may include generating, using one or more pressure sensors 610, a pressure input signal associated with data indicative of one or more pressures within the one or more electrochemical cells. The method 800 then proceeds to block 806.

At block 806, the method 800 includes comparing, using the controller 612, the one or more parameters to a threshold setpoint. If the parameters are outside a predetermined range of a predetermined set threshold, the method 800 proceeds to block 808. In this example, the method 800 may include comparing, using the controller 612, the pressure to a maximum pressure threshold. If the controller 612 determines that the pressure is above the maximum pressure threshold, the method 800 proceeds to block 808. If the controller 612 determines that the pressure is not above the maximum pressure threshold, the method 800 proceeds immediately to block 814.

At block 808, the method 800 includes generating, using the controller 612, the actuation signal responsive, at least in part, to the controller 612 determining that the parameter is outside a predetermined range of the threshold setpoint. In this example, the method 800 may include generating, using the controller 612, the first actuation signal responsive, at least in part, to the controller 612 determining that the pressure is above the maximum pressure threshold. The method 800 then proceeds to block 810.

At block 810, the method 800 includes adjusting, using the actuator 611, the tension force responsive, at least in part, to the actuator 611 receiving the actuation signal from the controller 612. In this example, the method 800 includes rotating, using the actuator 611, the tensioning device 510a (e.g., the first tensioning device 510b, the second tensioning device 510c, etc.) in the first rotational direction to decrease the tension force responsive, at least in part, to the actuator 611 receiving the first actuation signal from the controller 612. The method 800 then proceeds to block 812.

At block 812, the method 800 includes applying, using the first tensioning device 510b of the tensioning devices 510a, the tension force to the first tension member 509a and the second tension member 509b simultaneously. In this example, the method 800 may include rotating, using the actuator 611, the first tensioning device 510b in the first rotational direction. The method 800 may further include decreasing, using that first tensioning device 510b, the tension force in the first tension member 509a and the second tension member 509b simultaneously responsive, at least in part, to the actuator 611 rotating that first tensioning device 510b in the first rotational direction. The method 800 then returns to block 804.

At block 814, the method 800 includes comparing, using the controller 612, the pressure to a minimum pressure threshold. If the controller 612 determines that the pressure is below the minimum pressure threshold, the method 800 proceeds to block 816. If the controller 612 determines that the pressure is not below the minimum pressure threshold, the method 800 returns to block 804.

At block 816, the method 800 includes generating, using the controller 612, the second actuation signal responsive, at least in part, to the controller 612 determining that the pressure is below the minimum pressure threshold. The method 800 then proceeds to block 818.

At block 818, the method 800 includes adjusting, using the actuator 611, the tension force responsive, at least in part, to the actuator 611 receiving the actuation signal from the controller 612. In this example, the method 800 includes rotating, using the actuator 611, the first tensioning device 510b in the second rotational direction to increase the tension force responsive, at least in part, to the actuator 611 receiving the second actuation signal from the controller 612. The method 800 then proceeds to block 820.

At block 820, the method 800 includes applying, using the first tensioning device 510b of the tensioning devices 510a, the tension force to the first tension member 509a and the second tension member 509b simultaneously. In this example, the method 800 may include rotating, using the actuator 611, the first tensioning device 510b in the second rotational direction. The method 800 may further include increasing, using that first tensioning device 510b, the tension force in the first tension member 509a and the second tension member 509b responsive, at least in part, to that first tensioning device 510b rotating in the second rotational direction. The method 800 may further include applying, using the second tensioning device 510c of the tensioning devices 510a, the tension force to the third tension member 509c and the fourth tension member 509d simultaneously. In a somewhat similar manner, the method 800 may further include applying, using the third tensioning device (not shown) of the tensioning devices 510a, the tension force to a fifth tension member (not shown) and the sixth tension member (not shown) simultaneously. The method 800 may further include applying, using the fourth tensioning device (not shown) of the tensioning devices 510a, the tension force to a seventh tension member (not shown) and the eighth tension member (not shown) simultaneously. The method 800 returns to block 804.

In other implementations, the tensioning device may have other features that may be used to engage the tensioning device and apply a torque thereto, e.g., a hole or holes that extend into or through the tensioning device in directions transverse to the long axis of the tension member that may permit a device with a shaft, e.g., a screwdriver, to be to inserted therein or therethrough to allow torque to be applied to the tensioning device in order to rotate it.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

What is claimed is:

1. An electrochemical cell system comprising:
a cathode end plate;
an anode end plate;
one or more electrochemical cells positioned between the cathode end plate and anode end plate;
a plurality of tension members connecting the cathode end plate with the anode end plate; and
a plurality of tensioning devices, each configured to apply a tension force to one or more of the tension members such that the corresponding tension member or tension members apply a local compression force to a corresponding local portion of the cathode end plate and the anode end plate;
wherein the cathode end plate and the anode end plate distribute an aggregate compression force across the one or more electrochemical cells disposed between the cathode end plate and the anode end plate responsive, at least in part, to each corresponding local portion of the cathode end plate and the anode end plate receiving the local compression force from the corresponding tension member or tension members; and
wherein each tensioning device is positioned between the cathode end plate and the anode end plate and is spaced apart from each of the cathode end plate and the anode end plate.

2. The electrochemical cell system of claim 1, further comprising one or more regions adjacent to the cathode end plate and the anode end plate that are free of the tensioning devices, thereby further providing clearance for accessing one or more components connected to a corresponding one of the cathode end plate and the anode end plate.

3. The electrochemical cell system of claim 2, wherein one or both of the cathode end plate and the anode end plate includes:
a first face;
a second face opposite to the first face and directed towards the one or more electrochemical cells; and
one or more peripheral sides extending between the first face and the second face;
wherein the tension members are connected to the peripheral sides of one or both of the cathode end plate and the anode end plate and the tension members are positioned adjacent to the one or more electrochemical cells.

4. The electrochemical cell system of claim 3, wherein:
the cathode end plate and the anode end plate each include the corresponding first face, the corresponding second face, and the corresponding one or more peripheral sides,
the electrochemical cell system further includes a plurality of cathode plate pins extending from the one or more peripheral sides of the cathode end plate,
the electrochemical cell system further includes a plurality of anode plate pins extending from the one or more peripheral sides of the anode end plate, and
each tension member includes:
a first rod having a first end pivotably connected to one of the cathode plate pins and a second end including a first threaded portion;
a second rod having a first end pivotably connected to one of the anode plate pins and a second end including a second threaded portion; and
one or more of the tensioning devices;
wherein the first threaded portions and the second threaded portions of each tension member are threaded in opposite directions;
wherein the tensioning device of each tension member includes a corresponding first threaded portion rotationally coupled with the first threaded portion of the first rod of that tension member and a corresponding second threaded portion rotationally coupled with the second threaded portion of the second rod of that tension member;
wherein the corresponding first threaded portion and the corresponding second threaded portion of the tensioning device of each tension member are threaded in opposite directions;
wherein the tensioning device of each tension member is configured to decrease the tension force in that tension member responsive, at least in part, to that tensioning device rotating in a first rotational direction relative to the first and second rods; and
wherein the tensioning device of each tension member is configured to increase the tension force in that tension member responsive, at least in part, to that tensioning device rotating in a second rotational direction opposite to the first rotational direction.

5. The electrochemical cell system of claim 4, wherein the tensioning device of each tension member has an outer surface having a plurality of flat sides configured to be engaged by a rotational drive device to facilitate rotation of the tensioning device by rotating the rotational drive device in the first rotational direction or the second rotational direction.

6. The electrochemical cell system of claim 5, wherein each tension member includes a corresponding spring having a spring constant associated with the tension force.

7. The electrochemical cell system of claim 6, wherein the tensioning device of each tension member includes a tubular body with a helical slot along a length of the tubular body.

8. The electrochemical cell system of claim 3, wherein the plurality of tension members includes at least a first tension member and a second tension member, wherein a first tensioning device of the tensioning devices is configured to apply the tension force to the first tension member and the second tension member simultaneously.

9. The electrochemical cell system of claim 8, wherein each of the first tension member and the second tension member includes:
one or more connectors configured to connect with the first tensioning device;
a first load spreader connected to two or more pins that extend from one of the peripheral sides of the cathode end plate;
one or more first links connecting the first load spreader with the one or more connectors;
a second load spreader connected to two or more pins that extend from one of the peripheral sides of the anode end plate; and
one or more second links connecting the second load spreader with the one or more connectors; and
wherein the first tensioning device is configured to apply the tension force to the first links and the second links of the first tension member and the first links and the second links of the second tension member via the one or more connectors.

10. The electrochemical cell system of claim 9, wherein the first tension member includes a first threaded portion, the second tension member includes a second threaded portion, and the first tensioning device includes a corresponding first threaded portion rotationally coupled with the first threaded portion of the first tension member and a corresponding second threaded portion rotationally coupled with the second threaded portion of the second tension member;
the first threaded portion of the first tension member and the second threaded portion of the second tension member are threaded in opposite directions;
the corresponding first threaded portion and the corresponding second threaded portion of the first tensioning device are threaded in opposite directions;
the first tensioning device is configured to decrease the tension force in the first tension member and the second tension member responsive, at least in part, to the first tensioning device rotating in a first rotational direction relative to the first and second links; and
the first tensioning device is configured to increase the tension force in the first tension member and the second tension member responsive, at least in part, to the first tensioning device rotating in a second rotational direction opposite to the first rotational direction.

11. The electrochemical cell system of claim 10, wherein the first tensioning device has an outer surface having a plurality of flat sides configured to be engaged by a rotational drive device to facilitate rotation of that first tensioning device by rotating the rotational drive device in the first rotational direction or the second rotational direction.

12. The electrochemical cell system of claim 11, wherein each tension member includes a corresponding spring having a spring constant associated with the tension force.

13. The electrochemical cell system of claim 12, wherein the first tensioning device of each tension member includes a tubular body with a helical slot along a length of the tubular body.

14. The electrochemical cell system of claim 1, wherein each of the one or more electrochemical cells is an electrolyzer cell or a fuel cell.

15. The electrochemical cell system of claim 1, further comprising:
at least one actuator configured to rotate the corresponding tensioning devices; and
a controller configured to control the actuators to rotate the corresponding tensioning devices and adjust the tension forces applied to the tension members.

16. The electrochemical cell system of claim 15, further comprising:
one or more sensors configured to generate an input signal associated with data indicative of one or more parameters of the one or more electrochemical cells;
wherein the controller is configured to:
compare the one or more parameters to a threshold setpoint, and
generate an actuation signal responsive, at least in part, to the controller determining that the one or more parameters are outside a predetermined range of the threshold setpoint, and
wherein the actuator is configured to adjust the tension force responsive, at least in part, to the actuator receiving the actuation signal from the controller.

17. The electrochemical cell system of claim 15, further comprising:
one or more pressure sensors configured to generate a pressure input signal associated with data indicative of one or more pressures within the one or more electrochemical cells;
wherein the controller is configured to:
compare the one or more pressures to a maximum pressure threshold, and
generate a first actuation signal responsive, at least in part, to the controller determining that the one or more pressures are above the maximum pressure threshold, and
wherein the actuator rotates the tensioning device in a first rotational direction relative to the first and second tension members to decrease the tension force responsive, at least in part, to the actuator receiving the first actuation signal from the controller.

18. The electrochemical cell system of claim 17, wherein the controller is configured to:
compare the one or more pressures to a minimum pressure threshold, and
generate a second actuation signal responsive, at least in part, to the controller determining that the one or more pressures are below the minimum pressure threshold,
wherein the actuator rotates the tensioning device in a second rotational direction opposite to the first rotational direction to increase the tension force responsive, at least in part, to the actuator receiving the second actuation signal from the controller.

19. A method for configuring an electrochemical cell system having a cathode end plate, an anode end plate, one or more electrochemical cells positioned between the cathode end plate and the anode end plate, a plurality of tension members connecting the cathode end plate with the anode end plate, and a plurality of tensioning devices, the method comprising:
applying, using the tensioning devices, a tension force to one or more of the tension members such that the corresponding tension member applies a local compression force to a corresponding local portion of the cathode end plate and the anode end plate;
distributing, using the cathode end plate and the anode end plate, an aggregate compression force across the one or more electrochemical cells disposed between the cathode end plate and the anode end plate responsive, at least in part, to each corresponding local portion of the cathode end plate and the anode end plate receiving the local compression force from the corresponding tension member; and
disposing each tensioning device between the cathode end plate and the anode end plate and spacing apart each tensioning device from each of the cathode end plate and the anode end plate.

20. The method of claim 19, further comprising providing one or more regions adjacent to the cathode end plate and the anode end plate that are free of the tensioning devices, thereby further providing clearance for accessing one or more components connected to a corresponding one of the cathode end plate and the anode end plate.

21. The method of claim 20, wherein one or both of the cathode end plate and the anode end plate includes a first face, a second face opposite to the first face and directed towards the one or more electrochemical cells, and one or more peripheral sides extending between the first face and the second face, and the method further comprises:
connecting the tension members to the peripheral sides of one or both of the cathode end plate and the anode end plate; and
disposing the tension members adjacent to the one or more electrochemical cells, thereby decreasing a bending moment of the cathode end plate and the anode end plate.

22. The method of claim 21, further comprising:
pivotably connecting a first end of a first rod to one of a plurality of cathode plate pins extending from the one or more peripheral sides of the cathode end plate, with the first rod further including a second end including a first threaded portion;
pivotably connecting a first end of a second rod to one of a plurality of anode plate pins extending from the one or more peripheral sides of the anode end plate, with the second rod further including a second end including a second threaded portion;
rotating the tensioning device of the corresponding tension member in a first rotational direction relative to the first and second rods, with the tensioning device of the corresponding tension member including a corresponding first threaded portion rotationally coupled with the first threaded portion of the first rod of that tension member and a corresponding second threaded portion rotationally coupled with the second threaded portion of the second rod of that tension member;
decreasing, using the tensioning device of each tension member, the tension force in that tension member responsive, at least in part, to that tensioning device rotating in the first rotational direction;
rotating the tensioning device of the corresponding tension member in a second rotational direction; and
increasing, using the tensioning device of each tension member, the tension force in the that tension member responsive, at least in part, to that tensioning device rotating in the second rotational direction opposite to the first rotational direction.

23. The method of claim 21, further comprising applying, using a first tensioning device of the tensioning devices, the tension force to a first tension member and a second tension member simultaneously.

24. The method of claim 23, further comprising:
connecting one or more connectors of each one of the first tension member and the second tension member to the first tensioning device;
connecting a first load spreader of each one of the first tension member and the second tension member to two or more pins that extend from one of the peripheral sides of the cathode end plate;
connecting, using one or more first links of each one of the first tension member and the second tension member, the first load spreader with the one or more connectors;
connecting a second load spreader of each one of the first tension member and the second tension member to two or more pins that extend from one of the peripheral sides of the anode end plate;
connecting, using one or more second links of each one of the first tension member and the second tension member, the second load spreader with the one or more connectors; and
applying, using the first tensioning device, the tension force to the first links and the second links of the first tension member and the first links and the second links of the second tension member simultaneously.

25. The method of claim 24, further comprising:
rotating, in a first rotational direction relative to the first and second links, the first tensioning device, with that first tensioning device including a corresponding first threaded portion rotationally coupled with a first threaded portion of the first tension member and a corresponding second threaded portion rotationally coupled with a second threaded portion of the second tension member; and
decreasing, using that first tensioning device, the tension force in the tension member responsive, at least in part, to that first tensioning device rotating in the first rotational direction.

26. The method of claim 25, further comprising:
rotating in a second rotational direction opposite to the first rotational direction, that first tensioning device; and
increasing, using that first tensioning device, the tension force in the tension member responsive, at least in part, to that first tensioning device rotating in the second rotational direction.
